(19) United States
(12) Patent Application Publication
(10) Pub. No.: US 2004/0157572 A1
(43) Pub. Date: Aug. 12, 2004

(54) System and method for tuning radio service

(76) Inventor: Kumar Ramaswamy, Princeton, NJ (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/361,395

(22) Filed: Feb. 10, 2003

(51) Int. Cl. H04B 1/18

(52) U.S. Cl. 455/150.1; 455/154.1

(57) ABSTRACT

A wireless device comprises a user interface [208], a transport layer-processing module [206] connected to the user interface, and a cellular receiver [204] connected to the transport layer processing module for receiving a cellular signal comprising a radio channel guide. The wireless device further comprises a radio signal tuner [214] connected to the interface for receiving a radio signal, and an application layer [208] for tuning the radio receiver to a channel of the radio signal according to a user selection from the radio channel guide.

### BACKGROUND OF THE INVENTION

1. Field of Invention The present invention relates to wireless services, and more particularly to accessing broadcast content through cellular devices.

2. Discussion of Related Art

An important factor for delivering content over wireless networks is the cost of bandwidth. With the increasing proliferation of data networks, access to the Internet has been made possible over several networks, including for example, wireless local area networks (LANs) and cellular or fixed wireless networks. However, the cost of bandwidth is relatively high in wireless networks when compared to other means of content delivery.

Therefore, a need exists for system and method for tuning to content on a local broadcast system from an alternative wireless data network system.

### SUMMARY OF THE INVENTION

A wireless device comprises a user interface, a transport layer-processing module connected to the user interface, and a cellular receiver connected to the transport layer processing module for receiving a wireless signal comprising a radio channel guide. The wireless device further comprises a radio signal tuner connected to the interface for receiving a radio signal, and an application for tuning the radio receiver to a channel of the radio signal according to a user selection from the radio channel guide.

### BRIEF DESCRIPTION OF THE DRAWINGS

Preferred embodiments of the present invention will be described below in more detail, with reference to the accompanying drawings:

FIG. 1 is an illustration of a network according to an embodiment of the present invention;

FIG. 2 is a diagram of a tuner according to an embodiment of the present invention; and

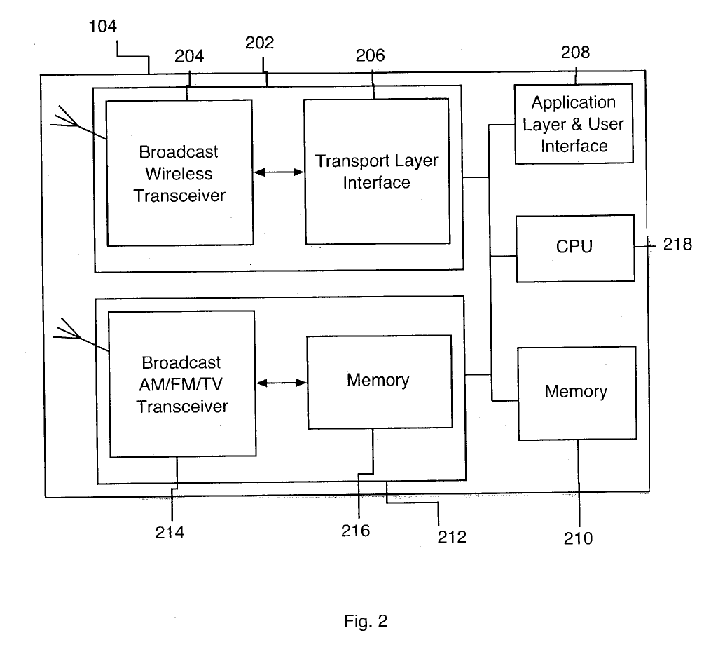

FIG. 3 is a flow chart of a method according to an embodiment of the present invention.

### DETAILED DESCRIPTION OF PREFERRED EMBODIMENTS

According to an embodiment of the present invention, a device can receive two or more different signals, for example, a two-way wireless signal and a broadcast radio signal. The device can be automatically tuned to a specific radio broadcast according to a selection from a channel guide. The channel guide is provided over a wireless channel and provides the user with an improved method for navigating content.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM) and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Existing AM and FM radio stations broadcast a variety of content. Receivers for these stations can be inexpensive and easy to implement. According to an embodiment of the present invention, a device can be automatically tuned to an analog AM/FM radio station using a channel guide provided by data server over a cellular channel. For example, a channel guide can be downloaded to the device and stored in memory. The channel guide can describe current radio broadcasts. The description can include a tuning frequency for the station and the genre of the station.

The device can have substantially no intelligence on the available content. The composition and selection of the guide information can happen on the server side of the interactive system. The wireless data channel can act as a control network with a command-response mechanism between the client device and the server. The client device can indicate its location, for example, based on geography and using a Global positioning system, or some other ranging mechanism available within a cellular infrastructure. The server composes an appropriate guide selection for content that is locally available on the broadcast channel to the client device. The guide look and feel can be tailored according to the display capabilities of the client device. The user can navigate through the available guide and make a specific selection. When such a selection is made, the server can send down the appropriate tuning information. On receiving this information, the client device tunes its broadcast receiver to the specific channel.

The channel guide can be formatted according to device capabilities. For example, for a device having a liquid crystal display for a user interface, the channel guide can be formatted in color or black-and-white and scaled to a device screen size. A user can define preferences for formatting the guide, for example, listing country music stations prominently or listing a particular syndicated show in a distinguishing color.

The channel guide can be updated at some rate, for example, once per day or every 15 minutes. The channel guide can be provided by a single source or be a compilation of data from each of the local stations. The rate of update can be based on, for example, the movement of the device. For example, a device that is moving rapidly, such as in a car, can be updated more frequently than a device that is stationary. The device can be implemented with, for example, a GPS system to determined a current position. The program guide can be updated with a change in content, for example, a new song or a listener's request. The program guide can be coarse at the level of the type of program currently being broadcast on a particular station. If finer grain programming is requested, then a real time update on each station can be performed on the website.

According to another embodiment of the present invention, the device can be automatically tuned to an analog AM/FM channel based on preprogrammed criterion such as time of day. The device can receive and store content in a memory for later retrieval. The content stored in memory can be compressed. A user can request a particular song or program and set the wireless device to automatically record the song when it is broadcast. Thus, the device can provide a virtual audio on demand function. Different genre of music can be categorized by a unique identifier that can be interactively selected by the device on its data network using an interactive mechanism. Once a genre of program or a specific program is selected, the sever sends down the appropriate broadcast channel tuning information.

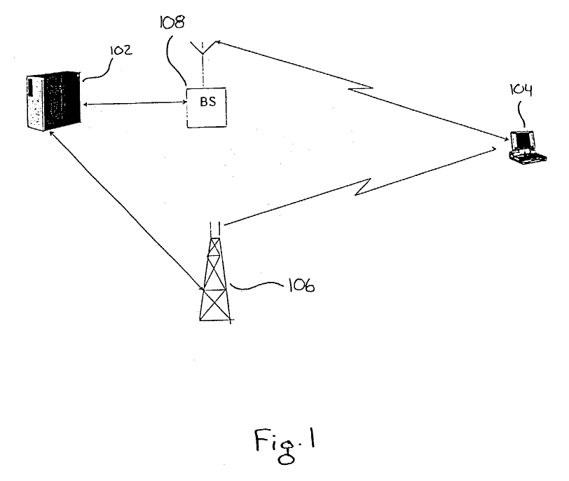

FIG. 1 shows a service where content providers subscribing to the Internet tuned radio services update the data server 102. A subscription fee can be charged to a registered user of the device, for example, yearly or on a per update basis. Further, the content providers such as radio stations 106, can be charged a subscription fee for having their content featured in the channel guide hosted on the data server 102. The user device, such as an intelligent terminal 104, is connected to the data server 102 via a cellular base station 108. The additional receiver is for tuning to the AM/FM broadcast station 106 that is transmitting the user selected program.

The intelligent terminal 104 comprises a wireless transceiver 202, comprising a cellular receiver 204 and a transport layer-processing module 206. The transport layer module 206 is responsible for access to a network, e.g., a wireless network, and for transfer of messages between the device and the data server 102. A memory 210 can be provided for storing a downloaded channel guide. The memory 210 can be coupled to the wireless transceiver or an application layer 208. The wireless transceiver can be connected to the application layer 208. The application layer 208 comprises a user interface. The application layer 208 can support a variety of applications providing the user device with extended capabilities. For example, a user can tune to a program at a predetermined time and record the program for later retrieval. The user interface can be implemented with, for example, a liquid crystal display for displaying a menu of options. The intelligent terminal further comprises a broadcast radio transceiver 212. The broadcast radio transceiver 212 comprises, for example, an AM/FM tuner 214. The terminal can also comprise a memory 216 such as FLASH memory, RAM and ROM. A CPU 218 can be coupled to the memories 210 and 216, the application layer 208 and the transceivers 202 and 212 for executing instructions.

According to an embodiment of the present invention, a service request can be made to a data server 102 comprising a name of a city, a zip code or some other identifying information. The data server 102 can return a guide with information including, but not limited to, a list of radio stations, the genre of available music and the tuning frequency for each radio station. The user can select a station and the receiver device automatically tunes the broadcast receiver to the requested station.

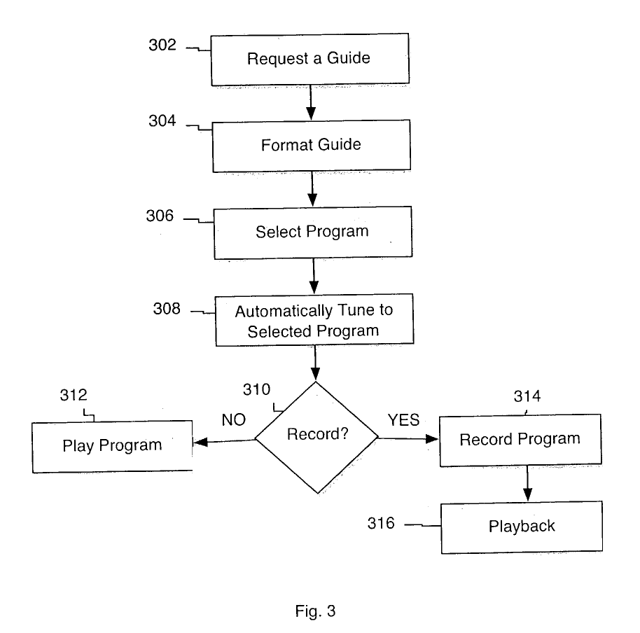

Referring to FIG. 3, a service can support device requests for a particular program from the data server station. A request can be made 302 of the data server through a data channel receiver. The request can specify a channel guide, for example, according to a geographic region. The request for the program can imply a time or a time for the program can be specified in the request. Upon receiving the channel guide, the guide can be stored in a memory. The guide can be formatted 304. A user can then navigate the channel guide and select a program 306. The device can automatically tune to a selected program 308. The device can query the user as to whether the program is to be recorded 310. If the user has selected playback, the program can be presented as it is received by the radio receiver. The device can automatically record the program 314 for later playback 316. Alternatively the device can play the program without querying the user.

It is to be understood that while embodiments of the invention have been presented using cellular service and radio stations as an example, that the invention is not limited to such an implementation. For example, channel guides caqn be served over Bluetooth enabled a local areas networks, or wireless Internet connections. The guides can be used to automatically access, for example, radio or television content.

Having described embodiments for a system for receiving analog content through a cellular device, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

1. A wireless device comprising:
a first receiver [204] connected to the transport layer processing module for receiving a first signal comprising a channel guide;
a second signal tuner [214] connected to the interface for receiving a second signal comprising a plurality of channels; and
an application layer [208] for tuning the second receiver to a channel of the second signal according to a user selection from the channel guide, wherein the channel guide describes at least one channel of the second signal.

2. The wireless device of claim 1, further comprising a memory coupled to the second signal tunder for storing content of the channel of the second signal according to the user selection.

3. The wireless device of claim 1, further comprising a memory coupled to the application layer for storing the channel guide.

4. A wireless device comprising:
a user interface [208];
a transport layer-processing module [206] connected to the user interface;
a cellular receiver [204] connected to the transport layer processing module for receiving a cellular signal comprising a radio channel guide;
a radio signal tuner [214] connected to the interface for receiving a radio signal; and
an application layer [208] for tuning the radio receiver to a channel of the radio signal according to a user selection from the radio channel guide.

5. The device of claim 4, wherein the radio signal tuner is connected to a memory, wherein the memory stores the radio signal.

6. The device of claim 4, wherein the user interface is a liquid crystal display.

7. The device of claim 4, wherein the user interface controls the application layer.

8. The device of claim 4, wherein the application formats the radio channel guide according to at least one user preference.

9. The device of claim 4, wherein the radio channel guide is a hypertext markup language document.

10. The device of claim 4, wherein the cellular receiver communicates with a server node, wherein the server node services requests for channel guides.

11. The device of claim 10, wherein the server node services requests for a fee charged to the user.

12. A method for tuning a wireless device to a desired radio channel comprising the steps of:
requesting a radio channel guide from a cellular based server;
formatting the radio channel guide according to a device specification;
presenting the radio channel guide to a user; and
tuning, automatically, to a radio channel according to a channel selected from the radio channel guide.

13. The method of claim 12, further comprising the step of formatting the radio channel guide according to at least one user preference.

14. The method of claim 13, wherein the step of formatting the radio channel guide comprises the step of presenting channels according to a user selected genre.

15. The method of claim 12, further comprising the steps of:
authenticating the wireless device upon requesting the radio channel guide; and
charging a fee to a user for servicing a request.

16. The method of claim 12, further comprising the step of updating the radio channel guide.

17. The method of claim 16, wherein the radio channel guide is updated upon determining one of a channel in location or a change in time.
